(19) United States
(12) Patent Application Publication
(10) Pub. No.: US 2007/0195541 A1
(43) Pub. Date: Aug. 23, 2007

(54) Illumination device

(75) Inventors: Heike Froehlich, Reutlingen (DE); Doris Boebel, Stuttgart (DE)

Correspondence Address: CENTRAL COAST PATENT AGENCY, INC, 3 HANGAR WAY SUITE D, WATSONVILLE, CA, 95076, US

(73) Assignee: Automotive Lighting Reutlingen GmbH

(21) Appl. No.: 11/701,318

(22) Filed: Jan. 31, 2007

(30) Foreign Application Priority Data
Feb. 17, 2006 (DE) 10 2006 007 450.5

(51) Int. Cl. B60Q 1/00

(52) U.S. Cl. 362/459

(57) ABSTRACT

In order to create an illumination device (1) with improved technical light characteristics for a vehicle, it is proposed that the illumination device (1) include a primary reflector (2) to create core light distribution, and a secondary reflector (3) interacting with a lens to create peripheral light distribution.

The invention relates to an illumination device in a vehicle, particularly a vehicle headlight.

The light emitted by automobile headlights must satisfy certain legal requirements that regulate, for example, the brightness and light distribution. Because of high traffic density, the so-called dimmed light is used as the driving light nowadays. Such headlights require, for example, a bright-dim limiting line in the light distribution according to the so-called ECE standard applicable in Europe. Light distribution including highbeam-lowbeam limiting line allows first to prevent dazzling the opposing traffic, and second to permit relatively high illumination strength below the highbeam-lowbeam line.

Along with maximum sight distance and minimum dazzling effect, the light distribution must also satisfy certain requirements at close range. For example, one must be able safely to negotiate curves, which is enabled by, for example, light distribution that extends laterally beyond the edges of the road.

Predominantly projective systems and reflective systems are currently used to create the most optimum light distribution.

Projective systems offer high overall light flow, along with good long-range and lateral illumination. Projective systems include a light source positioned at a first focal point of an ellipsoid-shaped reflector. Light beams emitted by the light source are reflected by the reflector and subsequently refracted by a (projection) lens in order to achieve a specific light distribution. The rainbow or spiral images are very large because of this two-staged configuration and normally very short focal lengths. It is thus difficult to reduce the illumination strength in specific areas, for example at short range. This generally causes loss in range and a non-homogenous short-range area, which may be distracting to the driver.

Reflective systems as a rule offer good core-light distribution and non-distracting foreground. Reflective systems, however, generally achieve poorer lateral illumination than do projective systems. Also, the overall light output is less in reflective systems since first, the light source used often provides lower light output, and second, the spatial configuration with respect to the available installation space is poorer than for projective systems.

It is the task of the invention to create an illumination device with improved technical light characteristics. Particularly, such an illumination device must enable long range, broad lateral illumination, and a high volume of light output while possessing small dimensions. Moreover, as homogenous a foreground as possible must be achieved with low level.

This task is solved by an illumination device of the above-mentioned type in that the illumination device possesses a primary reflector to create core light distribution and a secondary reflector interacting with a lens to create peripheral light distribution.

It is thereby possible to combine the advantages of a projective system with the advantages of a reflective system into a single illumination device. The primary reflector here acts as a reflective system, thus creating particularly good core illumination. The secondary reflector interacts with the lens like a projective system, thus creating homogenous base light distribution with high lateral illumination and low light level at close range in front of the vehicle.

The illumination device preferably includes a dimmer interacting with the secondary reflector, by means of which a highbeam-lowbeam line is created that complies with legal requirements.

The primary reflector may be advantageously configured so that the light reflecting from it creates an asymmetric highbeam-lowbeam line.

In the illumination device based on the invention, a portion of the light irradiated from the light source is resultantly emitted from the primary reflector, and another portion of the light from that same light source is emitted from the system comprising the secondary reflector and the lens. The lens for this may, for example, be a round, symmetrical lens.

The primary reflector is preferably formed from two laterally-positioned reflective elements. Conventional headlights in reflective technology are forced to possess a rectangular and very flat shape by installation space and design. This has the result that the reflective surface including the light source includes only a small spatial angle of the output emitted from the lamp. The overall light output from the system, and thus the degree of effectiveness, are thereby small since light is lost both in the upper and the lower area. Lateral positioning of the primary reflector thus has the advantage that the portion of the lamp output light emitted from the light source, which also possesses the greatest portion of overall light output even in conventional reflective systems, is used in the illumination device based on the invention for the reflective component and thus for the creation of core light distribution.

Resultantly, the light emitted upward and downward from the light source is mainly reflected by the secondary reflector and routed to the lens so that this component of the light output creates the base light distribution and simultaneously allows a high degree of lateral scattering.

The primary reflector is preferably largely parabolic-shaped. For this, the primary reflector may, for example, be part of a rotation paraboloid. This allows the use of a known procedure used to produce the primary reflector in the reflective system.

Similarly, the secondary reflector is preferably largely ellipsoid-shaped.

Per an advantageous embodiment of the illumination device based on the invention, the primary reflector and the secondary reflector are formed as one piece. This allows a particularly compact headlight design. This further allows both the primary reflector and the secondary reflector to be produced during a joint process, e.g., injection molding. Only one tool need be produced for this. Also, attachment elements by means of which the primary reflector must otherwise be affixed to the secondary reflector are no longer required. Moreover, the one-piece configuration possesses the advantage that particularly precise light distribution may be achieved since the interaction of the primary reflector with the secondary reflector may be pre-determined because of a high degree of manufacturing precision.

A lamp bracket is preferably mounted on the secondary reflector. It is particularly advantageous for this lamp bracket to be formed as one piece with the secondary reflector and thus as one piece with the primary reflector. This allows a still more efficient manufacture of the illumination device based on the invention. Also, a further reduction in installation space may be achieved.

Per another advantageous embodiment of the illumination device based on the invention, the lens is a cylindrical lens. Such a cylindrical lens allows refraction of the light reflected by the secondary reflector in such manner that a limitation of the irradiation upward angle may be achieved. It is not necessary to take into account the routing of the laterally-emitted light through the lens since this laterally-emitted light is reflected from the primary reflector and not the secondary reflector. Use of such a cylindrical lens allows, for example, a particularly flat design of illumination devices based on the invention. Moreover, a cylindrical lens is particularly inexpensive to produce.

The side of the lens facing away from the light source is preferably aspherically shaped. This allows achieval of a particularly homogenous light distribution with extensive lateral scattering. An aspherical lens may be produced with a higher aperture than can a non-aspherical lens, and thus has a higher degree of efficiency.

A scattering element is preferably assigned to the lens. Such a scattering element may, for example, possess wave-shaped profiles, and preferably cause horizontal scattering. The homogeneity of the light emitted from the illumination device may thus be increased even further. Moreover, desired light distribution may be achieved or optimized by means of the scattering lens.

It is particularly advantageous for the scattering lens to be of one piece with the cylindrical lens, particularly on the side facing the light source.

The light source is preferably implemented as a gas-discharge lamp. The gas-discharge lamp may be, for example, a so-called Xenon lamp. A particularly high light output level may thus be achieved.

Further advantages and application opportunities of the invention may be taken from [illustrations of] the subsequent embodiment examples, which show:

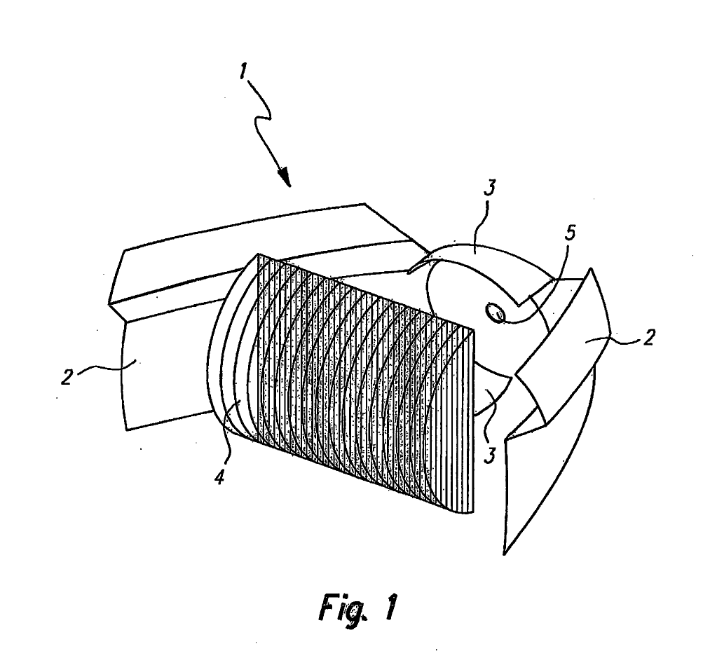

FIG. 1 schematic three-dimensional view of an illumination device based on an advantageous embodiment example;

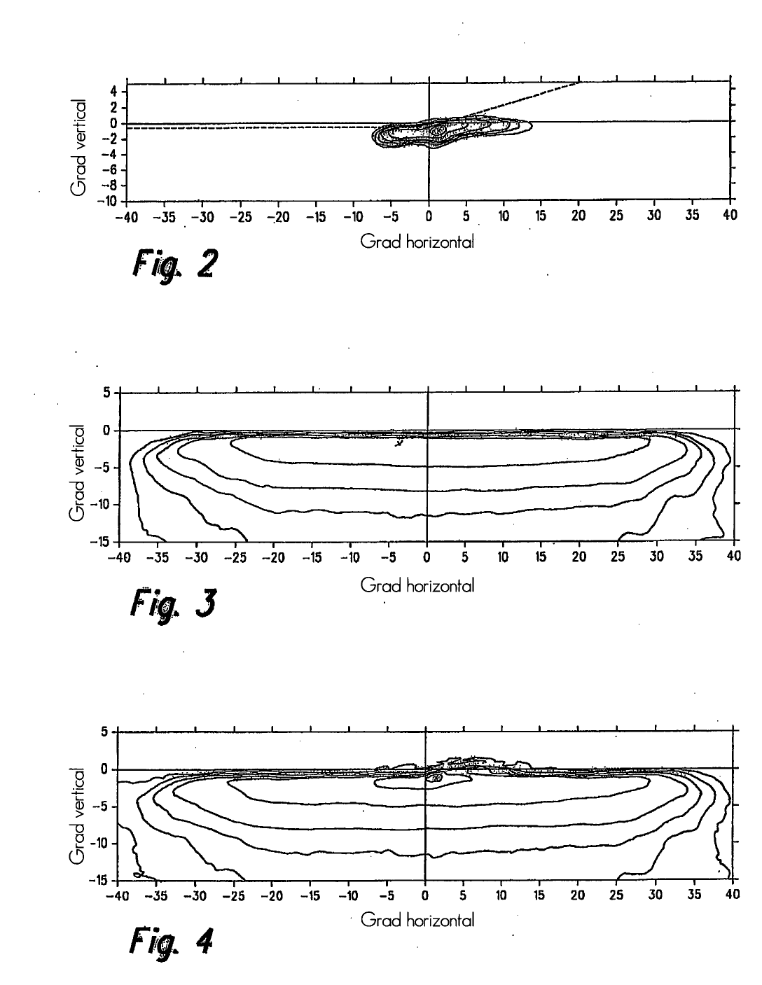

FIG. 2 representation of the core light distribution created by primary reflectors;

FIG. 3 representation of base light distribution created by a secondary reflector;

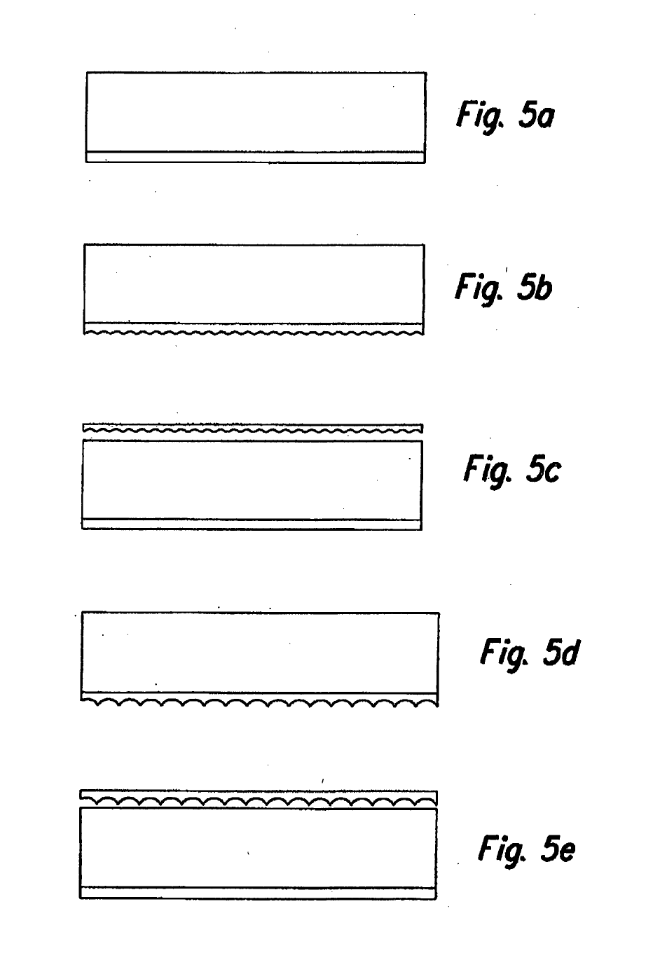

FIG. 4 schematic view of the overall light distribution;

FIGS. 5a through 5e schematic views of example cylindrical lenses as seen from above.

FIG. 1 shows a schematized three-dimensional view of an illumination device 1 based on the invention. The illumination device 1 includes a primary reflector 2 that consists of two laterally-mounted reflectors. A secondary reflector 3 is connected with the primary reflector 2 as one piece. The illumination device 1 further includes a cylindrical lens 4 and a light source 5.

The primary reflector 2 reflects the light laterally emitted from the light source 5, e.g. a gas-discharge lamp. The primary reflector 2 here is configured such that a highbeam-lowbeam line is created by the reflected light. The laterally positioned reflector elements of the primary reflector possess largely parabolic modified surfaces. The optical surfaces may, for example, be segmented or faceted.

The light reflected from the primary reflector 2 create the core light distribution with high range and an asymmetric highbeam-lowbeam line that, for example, includes a 15-degree sector. The primary reflector 2 uses only small rainbow or spiral images from the light source 5, and thereby generates a spatially limited light distribution that does not extend into the foreground in front of the vehicle.

The secondary reflector 3 consists an inner partially surrounding section, and an outer upper and lower wing. The inner part thus includes the entire light output (360°) that is emitted toward this surface. Beginning at a specific reflector depth, the light output from the light source 5 is divided between the upper/lower secondary reflector 3, and the right/left primary reflector 2.

The spiral or rainbow images are formed at an intermediary-image plane in which a light attenuator (not shown) is positioned. The light attenuator here lies approximately at the second focal point of the ellipsoid formed by the secondary reflector 3. For this, the light source 5 lies approximately at the first focal point of the ellipsoid. The intermediate image and the light attenuator also lie near the focal point of the horizontally-scattering cylindrical lens 4.

The cylindrical lens 4 enlarges the intermediate image and projects it onto the surface located in front of the illumination device 1, e.g., a street. The light reflected from the secondary reflector 3 creates a homogenous base light distribution with a high degree of lateral light distribution and a low light level in the immediate area in front of the vehicle. The highbeam-lowbeam line is hereby formed by the light attenuator (not shown), and possesses a horizontal, or largely horizontal, shape slanting upward at the outer portion. This slope is also 15°, for example. The shape and size of the secondary reflector 3 are so selected that a balanced ratio of base light distribution to the core light distribution created by the primary reflector 2 is achieved.

The light source 5, for example a so-called D2R lamp, is secured within a lamp bracket that is formed into the secondary reflector 3.

FIG. 2 shows an example of a core light distribution created by a primary reflector 2. The dashed line represents the ideal line of the highbeam-lowbeam line that possesses a 15° slope to the horizontal (0°). The core light distribution is created by means of the parabolic-shaped primary reflector 2 by reflection of the emitted light laterally from the light source 5. The core light distribution is of high intensity, and therefore achieves a high range.

FIG. 3 shows an example of the base light distribution that is formed by the interaction between the light emitted upward and downward from the light source 5 when it is reflected from the secondary reflector 3 and is emitted from illumination device 1 through the light attenuator and the cylindrical lens 4. The base light distribution shown in FIG. 3 possesses a particularly homogenous, and particularly laterally illuminating, light distribution.

FIG. 4 shows an example of the total light distribution as it may be created by the illumination device 1. Here, the light distributions created from the primary reflector 2 and the secondary reflector 3 to a particularly balanced overall light distribution with long range and high degree of lateral illumination, as well as a homogenous foreground illumination at low level. A relatively rectangular progression of the so-called iso-lux line achieves particularly good illumination in the lateral areas in front of the vehicle. The overall light distribution may be, for example, an additive of the light distributions shown in FIGS. 2 and 3.

FIGS. 5a-5e show embodiment examples for possible cylindrical lenses 4, and potential scattering lenses or potential combinations of these elements.

FIG. 5a shows a cylindrical lens 4 with no profile. FIG. 5b shows the top view of a cylindrical lens 4 with a horizontally-scattering wave profile 4a (e.g., like a sine or cosine function) mounted on its side facing toward the light source 5. FIG. 5c shows a separate scattering element 6 mounted on the side of the cylindrical lens 4 facing away from the light source 5. The scattering element 6 possesses a wave profile 6a (e.g., like a sine or cosine function) mounted on its side facing toward the light source 5.

FIG. 5d shows an embodiment example in which the horizontally-scattering profile 4b (e.g., like a component of a sine or cosine function) as shown in FIG. 5b, but with a larger profile.

FIG. 5e shows, similar to the embodiment example shown in FIG. 5c, a plano-convex cylindrical lens 4 with separate scattering element 6 that, however, possesses a profile with a higher degree of horizontal scattering (e.g., like a component of a sine or cosine function).

Depending on the requirements of the illumination device limposed, for example, by legal restrictions or by a specific shape the lens 4 may interact [with] a suitable scattering element in order to achieve the best possible light distribution. In particular, the lens 4 itself, as FIGS. 5b and 5d show, may include a profile on the side facing the light source.

It is also conceivable to use a plano-convex lens instead of the cylindrical lens 4, and to combine such lens with a scattering element.

Of course, the illumination device 1 may also be powered using a halogen lamp.

It is particularly conceivable to configure the primary reflector 2 such that it reflects a greater or a lesser portion or the light emitted upward or downward from the light source 5. In such case, the secondary reflector 3 may be configured to be correspondingly smaller. That is, the upper or the lower reflector element of the secondary reflector 3 reflects a smaller angular area of the light emitted from the light source 5.

It may also be provided that the secondary reflector 3 reflects a greater or a lesser portion or the light emitted laterally by the light source 5. The dimensions of the primary reflector 2 and of the secondary reflector 3 may vary resultantly. However, in combination with the lens 4, the core light area is primarily created by the primary reflector 2, and the base light area is primarily created by the secondary reflector 3.

1. Illumination device (1) in a vehicle, whereby the illumination device (1) includes a light source (5), characterized in that the illumination device (1) includes a primary reflector (2) to create a core light distribution and a secondary reflector (3) interacting with a lens to create peripheral light distribution.

2. Illumination device (1) as in claim 1, characterized in that the primary reflector (2) and the secondary reflector (3) are configured such that the primary reflector (2) and the secondary reflector (3) both reflect a partial output from the same light source (5).

3. Illumination device (1) as in claim 1 or 2, characterized in that the illumination device (1) includes a light attenuator interacting with the secondary reflector (3).

4. Illumination device (1) as in one of prior claims, characterized in that an asymmetrical highbeam-lowbeam line is created by the light reflected from the primary reflectors (2).

5. Illumination device (1) as in one of prior claims, characterized in that the primary reflector (2) is formed of two laterally-positioned reflector elements.

6. Illumination device (1) as in one of prior claims, characterized in that the primary reflector (2) is largely parabolic in shape.

7. Illumination device (1) as in one of prior claims, characterized in that the secondary reflector (3) is largely elliptical in shape.

8. Illumination device (1) as in one of prior claims, characterized in that the primary reflector (2) and the secondary reflector (3) are formed as one piece.

9. Illumination device (1) as in one of prior claims, characterized in that a lamp bracket is mounted on the secondary reflector (3).

10. Illumination device (1) as in one of prior claims, characterized in that the lens is selected to be a horizontally-oriented cylindrical lens (4).

11. Illumination device (1) as in one of prior claims, characterized in that the vertical cross-section of the side of the lens (4) facing away from the light source (5) is aspherical.

12. Illumination device (1) as in one of prior claims, characterized in that a scattering element is assigned to the lens.

13. Illumination device (1) as in claim 12, characterized in that the scattering element causes horizontal scattering.

14. Illumination device (1) as in claim 12, characterized in that on a side of the lens facing toward the light source, the scattering element is formed (5) as one piece with it.

15. Illumination device (1) as in one of prior claims, characterized in that the light source (5) is a gas-discharge lamp.

16. Illumination device (1) as in one of prior claims, characterized in that the primary reflector (2), or at least one or more parts of the primary reflector (2) is/are moveable to create a variable light distribution.
